(19) United States
(12) Patent Application Publication
(10) Pub. No.: US 2026/0162867 A1
(43) Pub. Date: Jun. 11, 2026

(54) MULTILAYER ELECTRONIC COMPONENT

(71) Applicant: TDK Corporation, Tokyo (JP)

(72) Inventors: Yusuke NAGAI, Tokyo (JP); Hidenobu UMEDA, Tokyo (JP); Kouichi KAKUDA, Tokyo (JP); Yuya ISHIMA, Tokyo (JP); Takuya MIYASHITA, Tokyo (JP); Kazuo IWAI, Tokyo (JP); Koki ITO, Akita (JP)

(73) Assignee: TDK Corporation, Tokyo (JP)

(21) Appl. No.: 19/409,305

(22) Filed: Dec. 4, 2025

(30) Foreign Application Priority Data
Dec. 9, 2024 (JP) 2024-214636

(51) Int. Cl. H01F 27/02

(52) U.S. Cl. CPC H01F 27/022

(57) ABSTRACT

A multilayer electronic component includes: an element body including a first main surface forming a mounting surface, a second main surface facing the first main surface, and a side surface adjacent to the first main surface and the second main surface, the element body including a plurality of particles. A proportion of the first main surface or the side surface occupied by gaps between the plurality of particles is less than a proportion of the second main surface occupied by the gaps.

### TECHNICAL FIELD

The present disclosure relates to a multilayer electronic component. This application claims priority based on Japanese Patent Application No. 2024-214636 filed on Dec. 9, 2024, the entire contents of which are incorporated herein by reference.

### BACKGROUND

A multilayer electronic component that includes an element body is known (see, for example, JP 2023-028451). JP 2023-028451 discloses that providing recessed portions in a main surface and a side surface of the element body increases the surface area of the element body and improves heat dissipation of an inductor component.

### SUMMARY

In a case where the inductor component is reflow-soldered to an electronic device, flux flows into the recessed portions provided in the main surface which is the mounting surface and the side surface adjacent to the mounting surface. Consequently, since the amount of flux relatively decreases, the wettability of the solder is reduced.

It is an object of the present disclosure to provide a multilayer electronic component that is capable of suppressing inflow of flux.
(1) A multilayer electronic component according to an aspect of the present disclosure includes: an element body including a first main surface forming a mounting surface, a second main surface facing the first main surface, and a side surface adjacent to the first main surface and the second main surface, the element body including a plurality of particles, wherein a proportion of the first main surface or the side surface occupied by gaps between the plurality of particles is less than a proportion of the second main surface occupied by the gaps.

In the above multilayer electronic component, there are fewer gaps on the first main surface which is the mounting surface and the side surface adjacent to the first main surface, which thereby makes it possible to suppress the inflow of flux.
(2) In the multilayer electronic component of (1) above, the proportion of the first main surface occupied by the gaps may be less than the proportion of the second main surface occupied by the gaps. In this case, the inflow of flux can be more effectively suppressed.
(3) In the multilayer electronic component of (2) above, the proportion of the side surface occupied by the gaps may be less than the proportion of the second main surface occupied by the gaps. In this case, the inflow of flux can be reliably and effectively suppressed.
(4) In the multilayer electronic component of any one of (1) to (3) above, the first main surface or the side surface may have a surface roughness less than a surface roughness of the second main surface. In this case, the inflow of flux can be suppressed.
(5) In the multilayer electronic component of any one of (1) to (4) above, the plurality of particles may be formed of a material including a soft magnetic metal. In this case, since gaps between the plurality of particles are likely to form, a configuration that suppresses the inflow of flux is effective.

### BRIEF DESCRIPTION OF THE DRAWINGS

FIG. 1 is a perspective view illustrating an embodiment of a multilayer electronic component.

FIG. 2 is a diagram illustrating a cross-sectional configuration of the multilayer electronic component of FIG. 1.

FIG. 3 is a perspective view illustrating a configuration of a coil.

FIG. 4 is an enlarged schematic plan view illustrating a portion of a mounting surface.

FIG. 5 is an enlarged schematic plan view illustrating a portion of a side surface.

FIG. 6 is an enlarged schematic plan view illustrating a portion of a top surface.

### DETAILED DESCRIPTION

Embodiments of the present disclosure will be described in detail below with reference to the accompanying drawings. Same reference signs are given to the same or corresponding elements in the description of the drawings, and redundant description will be omitted.

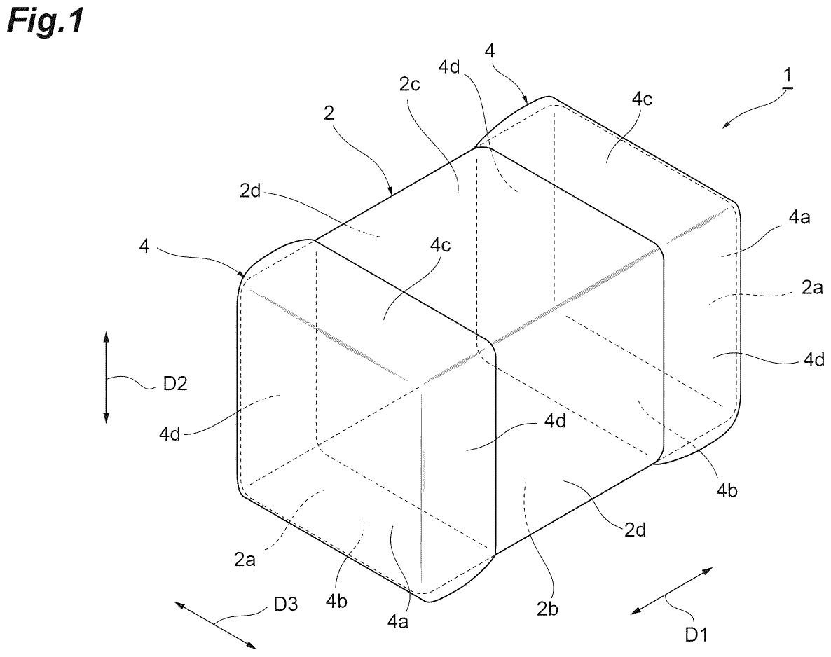

A multilayer electronic component 1 according to this embodiment will be described with reference to FIGS. 1 to 5. As illustrated in FIG. 1, the multilayer electronic component 1 includes an element body 2 having a rectangular parallelepiped shape and a pair of external electrodes 4, 4. The external electrodes 4, 4 are respectively disposed on both end portions of the element body 2 and are spaced apart from each other. The rectangular parallelepiped shape includes a rectangular parallelepiped shape in which the corners and edges are chamfered, and a rectangular parallelepiped shape in which the corners and edges are rounded. The multilayer electronic component 1 is, for example, a coil component. The multilayer electronic component 1 can be applied, for example, to a bead inductor or a power inductor.

The element body 2 having a rectangular parallelepiped shape has a pair of side surfaces 2a, 2a that face each other, a pair of main surfaces 2b, 2c that face each other, and a pair of side surfaces 2d, 2d that face each other. The side surfaces 2a, 2a are located adjacent to the pair of main surfaces 2b, 2c. The side surfaces 2d, 2d are located adjacent to the pair of main surfaces 2b, 2c.

The main surface 2b (bottom surface in FIG. 1) forms a mounting surface. The mounting surface is the surface that faces another electronic device (circuit board, electronic component, etc.) when the multilayer electronic component 1 is mounted to another electronic device. The main surface 2c (top surface in FIG. 1) forms a marked surface on which a mark indicating the orientation of the element body 2 is provided. The mark may be provided on the side surfaces 2a, 2d.

In this embodiment, the facing direction between the pair of side surfaces 2a, 2a (first direction D1) is a longitudinal direction of the element body 2. The facing direction between the pair of main surfaces 2b, 2c (second direction D2) is a vertical direction of the element body 2. The facing direction between the pair of side surfaces 2d, 2d (third direction D3) is a lateral direction of the element body 2. The first direction D1, the second direction D2, and the third direction D3 are orthogonal to each other.

The element body 2 has a length in the first direction D1 greater than lengths of the element body 2 in the second direction D2 and the third direction D3. The element body 2 has a length in the second direction D2 equivalent to the length of the element body 2 in the third direction D3. That is, in this embodiment, the pair of side surfaces 2a, 2a have a square shape, and the pair of main surfaces 2b, 2c and the pair of side surfaces 2d, 2d have a rectangular shape.

The element body 2 may have a length in the first direction D1 equivalent to the lengths of the element body 2 in the second direction D2 and the third direction D3. The element body 2 may have a length in the second direction D2 different from the length of the element body 2 in the third direction D3. Equivalent includes minute differences or manufacturing errors within a preset range, in addition to meaning the same. For example, if a plurality of values are included in a ±5% range of an average value of the plurality of values, it is considered that the plurality of values are equivalent.

The pair of side surfaces 2a, 2a extend in the second direction D2 so as to connect the pair of main surfaces 2b, 2c. The pair of side surfaces 2a, 2a also extend in the third direction D3 so as to connect the pair of side surfaces 2d, 2d. The pair of main surfaces 2b, 2c extend in the first direction D1 so as to connect the pair of side surfaces 2a, 2a. The pair of main surfaces 2b, 2c also extend in the third direction D3 so as to connect the pair of side surfaces 2d, 2d. The pair of side surfaces 2d, 2d extend in the first direction D1 so as to connect the pair of side surfaces 2a, 2a. The pair of side surfaces 2d, 2d also extend in the second direction D2 so as to connect the pair of main surfaces 2b, 2c.

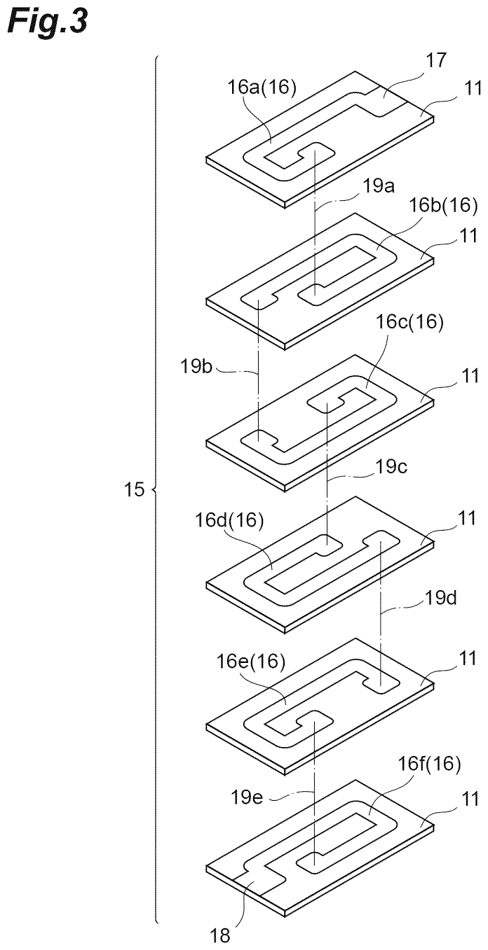

The element body 2 is formed by a plurality of magnetic layers 11 (see FIG. 3) being laminated. The magnetic layers 11 are laminated in the facing direction between the main surfaces 2b, 2c. That is, a lamination direction of the magnetic layers 11 coincides with the facing direction between the main surfaces 2b, 2c (hereinafter, the facing direction between the main surfaces 2b, 2c is referred to as the “lamination direction”). The magnetic layers 11 have a substantially rectangular shape. In an actual element body 2, the magnetic layers 11 are integrated such that the boundaries between the layers thereof cannot be visually recognized.

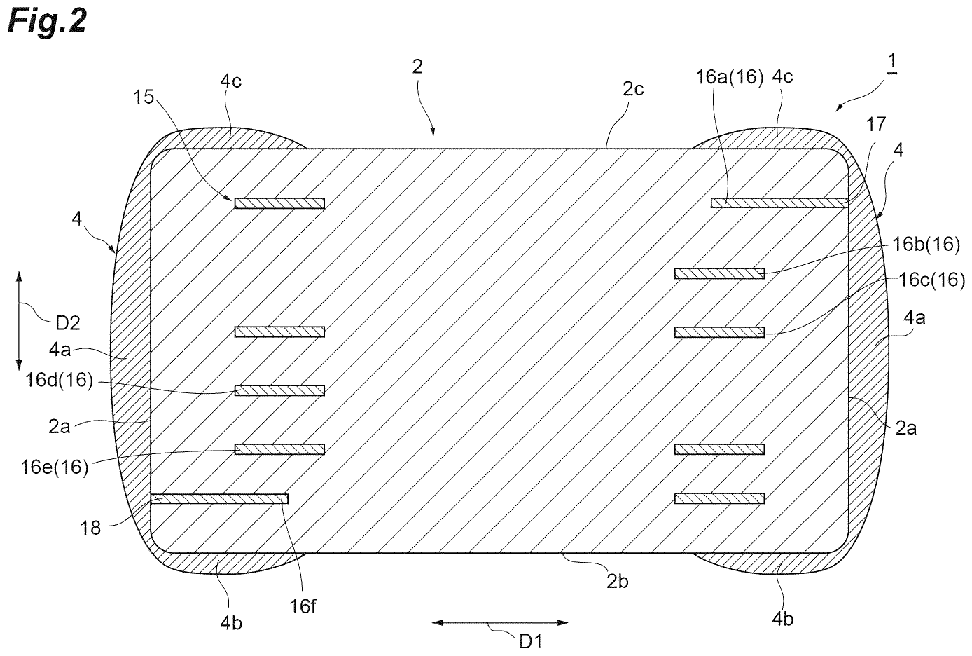

As illustrated in FIGS. 2 and 3, a coil 15 is disposed inside the element body 2. The coil 15 includes a plurality of coil conductors 16 (16a to 16f). The plurality of coil conductors 16a to 16f include a conductive material (e.g., Ag or Pd). The plurality of coil conductors 16a to 16f are formed as sintered bodies of a conductive paste including a conductive material (e.g., an Ag powder or a Pd powder).

The coil conductor 16a includes a connecting conductor 17. The connecting conductor 17 is disposed on a side of one of the side surfaces 2a of the element body 2 and has an end portion that is exposed on the one of the side surfaces 2a. The end portion of the connecting conductor 17 is exposed on the one of the side surfaces 2a at a position closer to the main surface 2c and is connected to one of the external electrodes 4. That is, the coil 15 is electrically connected to the one of the external electrodes 4 via the connecting conductor 17. In this embodiment, a conductive pattern of the coil conductor 16a and a conductive pattern of the connecting conductor 17 are continuously and integrally formed.

The plurality of coil conductors 16a to 16f are formed in the lamination direction of the magnetic layers 11 inside the element body 2. The plurality of coil conductors 16a to 16f are arranged in the order of the coil conductor 16a, the coil conductor 16b, the coil conductor 16c, the coil conductor 16d, the coil conductor 16e, and the coil conductor 16f. In this embodiment, the coil 15 is formed of the portion of the coil conductor 16a other than the connecting conductor 17, the coil conductors 16b to 16e, and the portion of the coil conductor 16f other than a connecting conductor 18.

End portions of the coil conductors 16a to 16f are connected to each other by through-hole conductors 19a to 19e. The coil conductors 16a to 16f are electrically connected to each other by the through-hole conductors 19a to 19e. The coil 15 is formed by the plurality of coil conductors 16a to 16f being electrically connected. Each of the through-hole conductors 19a to 19e includes a conductive material (e.g., Ag or Pd). Similarly to the plurality of coil conductors 16a to 16f, each of the through-hole conductors 19a to 19e is formed as a sintered body of a conductive paste including a conductive material (e.g., an Ag powder or a Pd powder).

Each of the external electrodes 4 is disposed so as to cover the end portion of the element body 2 on the side surface 2a side. As illustrated in FIG. 1, the external electrode 4 has an electrode portion 4a that covers the side surface 2a, electrode portions 4b, 4c that extend over the pair of main surfaces 2b, 2c, and electrode portions 4d, 4d that extend over the pair of side surfaces 2d, 2d. That is, the external electrode 4 is formed by the five surfaces of the electrode portions 4a, 4b, 4c, 4d, 4d.

Each of the electrode portions 4a is disposed so as to cover the entire end portion of the connecting conductor 17 exposed on one of the side surfaces 2a and the entire end portion of the connecting conductor 18 of the other side surface 2a, and the connecting conductors 17, 18 are directly connected to the external electrodes 4. That is, the connecting conductors 17, 18 connect end portions of the coil 15 and the electrode portions 4a. Accordingly, the coil 15 is electrically connected to the external electrodes 4.

The electrode portions 4a, 4b, 4c, 4d, 4d adjacent to each other are continuous over edge portions of the element body 2 and are electrically connected. The electrode portion 4a and the electrode portion 4b are connected at the edge portion between the side surface 2a and the main surface 2b. The electrode portion 4a and the electrode portion 4c are connected at the edge portion between the side surface 2a and the main surface 2c. The electrode portion 4a and the electrode portion 4d are connected at the edge portion between the side surface 2a and the side surface 2d.

The external electrodes 4 are formed including a conductive material. The conductive material is, for example, Ag or Pd. The external electrodes 4 are baked electrodes and formed as sintered bodies of a conductive paste. The conductive paste includes a conductive metal powder and glass frit. The conductive metal powder is, for example, an Ag powder or a Pd powder. A plating layer is formed on the surfaces of the external electrodes 4. The plating layer is formed, for example, by electroplating. The electroplating is, for example, electrolytic Ni plating or electrolytic Sn plating.

Next, the configuration of the element body 2 described above will be described in further detail.

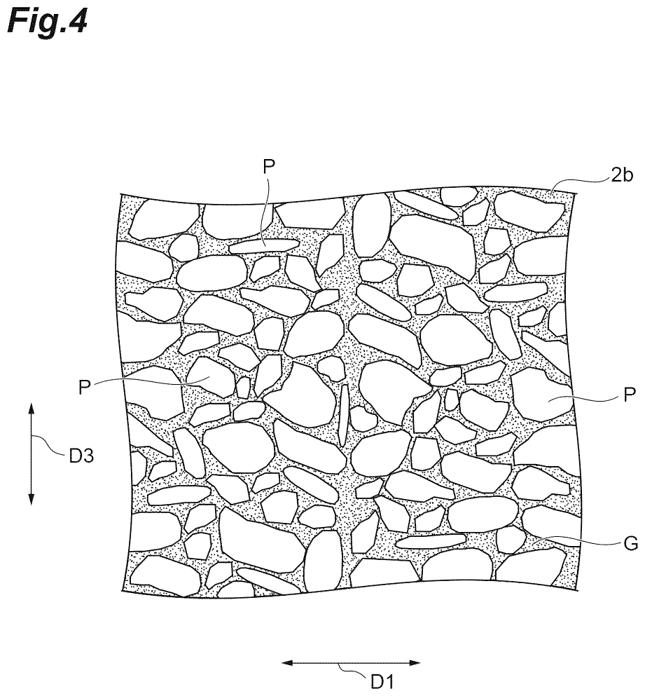

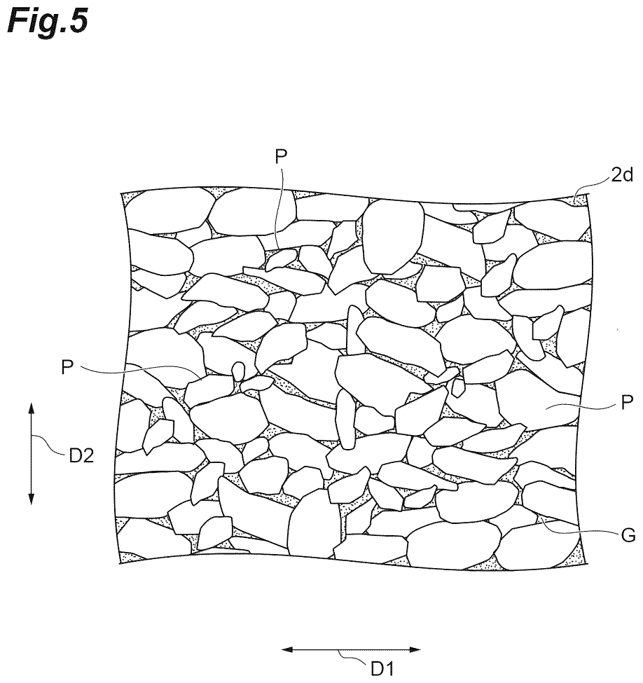

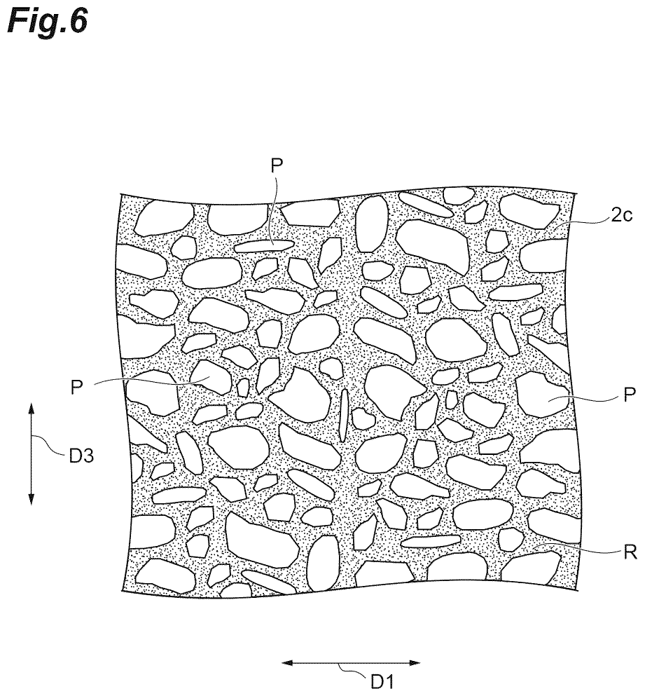

FIG. 4 is an enlarged schematic plan view illustrating a portion of a mounting surface (main surface 2b) as viewed from a direction perpendicular to the mounting surface. FIG. 5 is an enlarged schematic plan view illustrating a portion of a side surface (side surface 2d) as viewed from a direction perpendicular to the side surface. FIG. 6 is an enlarged schematic plan view illustrating a portion of a top surface (main surface 2c) as viewed from a direction perpendicular to the top surface. As illustrated in FIGS. 4 to 6, the element body 2 includes a plurality of particles P. The plurality of particles P are formed, for example, of a magnetic material including a soft magnetic metal. Such a magnetic material includes a soft magnetic alloy, for example, an Fe—Si alloy. The Fe—Si alloy may include P. The soft magnetic alloy may be, for example, an Fe—Ni—Si—M alloy. “M” includes one or more elements selected from Co, Cr, Mn, P, Ti, Zr, Hf, Nb, Ta, Mo, Mg, Ca, Sr, Ba, Zn, B, Al, and rare earth elements. The plurality of particles P may be formed of a magnetic material including ferrite or a dielectric material.

In the element body 2, the particles P, P are bonded to each other. The bonding of the particles P, P are achieved, for example, by the bonding of oxide films formed on the surfaces of the particles P, P. The element body 2 includes a portion that is filled with resin. The resin is present in at least a part of regions between the plurality of particles P, P. The resin has electrical insulating properties. For example, a silicone resin, a phenol resin, an acrylic resin, or an epoxy resin is used for the resin. Void portions not filled with the resin may be present between the plurality of particles P, P.

The plurality of particles P are exposed on the surfaces of the element body 2. Gaps G are present between the plurality of particles P that are exposed on the surfaces of the element body 2. The proportion of the main surface 2b occupied by the gaps G is less than the proportion of the main surface 2c occupied by the gaps G. The proportion of the pair of side surfaces 2d, 2d occupied by the gaps G is less than the proportion of the main surface 2c occupied by the gaps G. Although the illustration of a plan view of the pair of side surfaces 2a, 2a is omitted, the proportion of the pair of side surfaces 2a, 2a occupied by the gaps G is equivalent to the proportion of the pair of side surfaces 2d, 2d occupied by the gaps G. That is, the proportion of the pair of side surfaces 2a, 2a occupied by the gaps G is less than the proportion of the main surface 2c occupied by the gaps G. The proportion of the pair of side surfaces 2a, 2a occupied by the gaps G may be different from the proportion of the pair of side surfaces 2d, 2d occupied by the gaps G.

The proportion of the pair of side surfaces 2a, 2a occupied by the gaps G and the proportion of the pair of side surfaces 2d, 2d occupied by the gaps G are each less than the proportion of the main surface 2b occupied by the gaps G. The pair of side surfaces 2a, 2a and the pair of side surfaces 2d, 2d are surfaces formed by cutting using a dicing blade. Each of the particles P on the pair of side surfaces 2a, 2a and the pair of side surfaces 2d, 2d is characterized by being elongated in a cutting direction and having a large area compared to each of the particles P on the main surface 2b. The cutting direction is the tangential direction of the dicing blade. The cutting direction of the side surface 2d is the first direction D1 and the cutting direction of the side surface 2a is the third direction D3.

The proportion of each surface of the element body 2 occupied by the gaps G is measured, for example, as follows. First, each surface of the element body 2 is observed by a scanning electron microscope (SEM) from a direction perpendicular to the surface to obtain an SEM image. Image analysis of the SEM image obtained is then performed to identify the particles P and the gaps G. The particles P and the gaps G can be identified from differences in contrast in the image. Finally, the area ratio of the gaps G is calculated and this value is referred to as the proportion of the surface occupied by the gaps G.

The main surface 2b has a surface roughness less than a surface roughness of the main surface 2c. The pair of side surfaces 2a, 2a and the pair of side surfaces 2d, 2d have surface roughnesses less than the surface roughness of the main surface 2c. The pair of side surfaces 2a, 2a and the pair of side surfaces 2d, 2d have surface roughnesses equivalent to each other, but may have different surface roughnesses. The pair of side surfaces 2a, 2a and the pair of side surfaces 2d, 2d have surface roughnesses less than the surface roughness of the main surface 2b. The surface roughness is, for example, the arithmetic average roughness (Ra).

A method for producing the element body 2 will be described.

First, a multilayer green substrate including a plurality of laminated magnetic green sheets and conductive paste films to be inner conductors is prepared. The magnetic green sheets are formed by applying a magnetic slurry including, for example, the plurality of particles P, an insulating resin, and a solvent onto a substrate (e.g., a PET film) by a screen printing method, a doctor blade method, or the like. For the lowermost layer of the multilayer green substrate (i.e., the layer having the surface to be the main surface 2b), a magnetic green sheet, which has been subjected to calendering to compress the gaps G between the particles P, is used. The conductive paste films are formed on corresponding magnetic green sheets, for example, by a plating method, a screen printing method, or the like.

The multilayer green substrate is then cut into chips of a predetermined size with a dicer including a rotary blade to form a plurality of laminates divided into pieces. The cut surfaces formed by the rotary blade are to be the pair of side surfaces 2a, 2a and the pair of side surfaces 2d, 2d. The state of the particles P and the gaps G on the cut surfaces can be adjusted by adjusting the dicing conditions. For example, as the rotational speed of the rotary blade increases, the particles P deform more and the gaps G are compressed more.

Next, the divided laminates are sintered. A conductive paste is then applied onto the outer surfaces of each of the sintered laminates, and the conductive paste is baked onto the laminate by performing a heat treatment to form the external electrodes 4. Subsequently, the sintered laminate is immersed in a resin solution, and after impregnating the laminate with resin, the resin on the surfaces of the laminate is washed away with toluene. By washing away the resin, gaps are formed on the surfaces of the laminate. The resin impregnated into the laminate is then cured by heat and the element body 2 is formed. Subsequently, plating may be applied on the external electrodes 4. The multilayer electronic component 1 is thus obtained.

As described above, in the multilayer electronic component 1, there are fewer gaps on the main surface 2b and each of the side surfaces 2a, 2d. Since the main surface 2b is the mounting surface, having fewer gaps on the main surface 2b makes it possible to suppress the flow of solder flux applied to the mounting surface into the gaps. Since each of the side surfaces 2a, 2d is adjacent to the mounting surface, the solder may flow from the mounting surface into regions of each of the side surfaces 2a, 2d on the mounting surface side. Even in this case, since there are fewer gaps on each of the side surfaces 2a, 2d, it is possible to suppress the flow of flux into the gaps. As a result, the amount of flux relatively decreases, which can thereby suppress reduction in the wettability of the solder. In particular, since the external electrodes 4 are formed on the side surfaces 2a, 2d, a configuration in which the inflow of flux is suppressed is effective.

Since the plurality of particles P are formed of a material including a soft magnetic metal, gaps are more likely to form between the plurality of particles P compared, for example, to a case where the plurality of particles P are formed of a ferrite material. Accordingly, the configuration in which the inflow of flux is suppressed is especially effective.

Although the embodiments have been described above, the present invention is not necessarily limited to these embodiments, and various modifications are possible without departing from the gist thereof. The embodiments and variations described above may be combined as appropriate.

What is claimed is:

1. A multilayer electronic component comprising:
an element body including a first main surface forming a mounting surface, a second main surface facing the first main surface, and a side surface adjacent to the first main surface and the second main surface, the element body including a plurality of particles,
wherein a proportion of the first main surface or the side surface occupied by gaps between the plurality of particles is less than a proportion of the second main surface occupied by the gaps.

2. The multilayer electronic component according to claim 1, wherein the proportion of the first main surface occupied by the gaps is less than the proportion of the second main surface occupied by the gaps.

3. The multilayer electronic component according to claim 2, wherein the proportion of the side surface occupied by the gaps is less than the proportion of the second main surface occupied by the gaps.

4. The multilayer electronic component according to claim 1, wherein the first main surface or the side surface has a surface roughness less than a surface roughness of the second main surface.

5. The multilayer electronic component according to claim 1, wherein the plurality of particles are formed of a material including a soft magnetic metal.

6. The multilayer electronic component according to claim 1, further comprising an external electrode disposed on the element body.

7. The multilayer electronic component according to claim 6, further comprising a coil connected to the external electrode and disposed in the element body.

8. The multilayer electronic component according to claim 1, wherein the element body includes a resin.

9. The multilayer electronic component according to claim 8, wherein the resin has electrical insulating properties.

10. The multilayer electronic component according to claim 1, wherein the side surface is a cut surface by a dicing blade.

11. The multilayer electronic component according to claim 10, wherein the plurality of particles on the side surface are elongated in a cutting direction of the dicing blade.

12. A multilayer electronic component comprising:
an element body including a first main surface forming a mounting surface, a second main surface facing the first main surface, and a side surface adjacent to the first main surface and the second main surface, the element body including a plurality of particles formed of a material including a soft magnetic metal; and
a coil disposed in the element body,
wherein a proportion of each of the first main surface and the side surface occupied by gaps between the plurality of particles is less than a proportion of the second main surface occupied by the gaps.
